(19) United States
(12) Patent Application Publication
(10) Pub. No.: US 2008/0131075 A1
(43) Pub. Date: Jun. 5, 2008

(54) TRICK PLAY DVR WITH AUDIO PITCH CORRECTION

(75) Inventors: Romulo Pontual, Larchmont, NY (US); Robert G. Arsenault, Redondo Beach, CA (US)

Correspondence Address: THE DIRECTV GROUP, INC.;PATENT DOCKET ADMINISTRATION, CA / LA1 / A109, P O BOX 956, EL SEGUNDO, CA, 90245-0956, US

(73) Assignee: The DIRECTV Group, Inc., El Segundo, CA (US)

(21) Appl. No.: 11/947,564

(22) Filed: Nov. 29, 2007

Related U.S. Application Data
(60) Provisional application No. 60/872,083, filed on Dec. 1, 2006.

(51) Int. Cl. H04N 5/91

(52) U.S. Cl. 386/66; 386/104; 386/E05.001

(57) ABSTRACT

Systems for providing substantially correct pitch audio associated with video played back at a rate other than originally recorded. A system in accordance with the present invention comprises a record/playback device, wherein the record/playback device records audio programming and associated video programming at a normal speed and plays back the recorded audio programming and associated video programming at a range of speeds, a computer, coupled to the record/playback device, for determining the playback speed of the record/playback device, and an audio controller, coupled to the computer, for amending the audio programming to match a playback speed of the associated video programming while substantially maintaining the pitch of the audio programming.

### CROSS-REFERENCE TO RELATED APPLICATIONS

This application claims the benefit under 35 U.S.C. Section 119(e) of co-pending and commonly-assigned U.S. provisional patent application Ser. No. 60/872,083, filed Dec. 1, 2006, entitled “TRICK PLAY DVR WITH AUDIO PITCH CORRECTION,” by Robert G. Arsenault et al., which application is incorporated by reference herein.

### BACKGROUND OF THE INVENTION

1. Field of the Invention

The present invention relates generally to digital audio signal processing, and, more particularly, the present invention relates to a method for modifying the output rate of audio signals without changing the pitch. Specifically, the present invention relates to a satellite receiver system, and in particular, to a system architecture for presentation of audio in a proper pitch at playback speeds that do not match the original recording speed.

2. Description of the Related Art

Satellite broadcasting of communications signals has become commonplace. Satellite distribution of commercial signals for use in television programming currently utilizes multiple feedhorns on a single Outdoor Unit (ODU) which supply signals to up to eight IRDs on separate cables from a multiswitch.

FIG. 1 illustrates a typical satellite television installation of the related art.

System 100 illustrates a Direct Broadcast Satellite (DBS) system 100, which uses signals sent from Satellite A (SatA) 102, Satellite B (SatB) 104, and Satellite C (SatC) 106 that are directly broadcast to an Outdoor Unit (ODU) 108 that is typically attached to the outside of a house 110. ODU 108 receives these signals and sends the received signals to IRD 112, which decodes the signals and separates the signals into viewer channels, which are then passed to television 114 for viewing by a user. There can be more than one satellite transmitting from each orbital location.

Satellite uplink signals 116 are transmitted by one or more uplink facilities 118 to the satellites 102-104 that are typically in geosynchronous orbit. Satellites 102-106 amplify and rebroadcast the uplink signals 116, through transponders located on the satellite, as downlink signals 120. Depending on the satellite 102-106 antenna pattern, the downlink signals 120 are directed towards geographic areas for reception by the ODU 108.

Each satellite 102-106 broadcasts downlink signals 120 in typically thirty-two (32) different frequencies, which are licensed to various users for broadcasting of programming, which can be audio, video, or data signals, or any combination. These signals are typically located in the Ku-band of frequencies, i.e., 11-18 GHz. Future satellites will likely broadcast in the Ka-band of frequencies, i.e., 18-40 GHz, but typically 20-30 GHz.

FIG. 2 is a block diagram of a typical IRD 112, which receives and decodes audio, video and data signals. Typically, IRD 112 is a “set top box,” which is usually resident in a home or multi-dwelling unit, for reception of satellite broadcasted television signals 120.

Receiver dish 108 can be an Outdoor Unit (ODU), which is usually a smaller dish antenna mounted on a home or multi-dwelling unit. However, receiver dish 108 can also be a larger ground-mounted antenna dish if desired.

Receiver dish 108 typically uses a reflector dish and feedhorn assembly to receive and direct downlink signals 120 to IRD 112 via a wire or coaxial cable. Each IRD 112 has a dedicated cable that allows receiver dish 108, via a multiswitch, to selectively direct downlink signals 120 to IRD 112, and allows IRD 112 to determine which of the signals 120 is desired.

IRD 112 further includes alternate content source 202, receiver 204, remote control 210 and access card 212. IRD 112 can optionally include recording device 208, in which case, IRD 112 is known as a Personal Video Recorder (PVR) or Digital Video Recorder (DVR) 112. Receiver 204 includes tuner 214, demodulator/Forward Error Correction (FEC) decoder 216, digital-to-analog (D/A) converter 218, CPU 220, clock 222, memory 224, logic circuit 226, interface 228, infrared (IR) receiver 230 and access card interface 232. Receiver dish 108 receives signals 120 sent by satellites 102-106, amplifies the signals 120 and passes the signals 120 on to tuner 214. Tuner 214 and demodulator/FEC decoder 216 operate under control of CPU 220.

The CPU 220 operates under control of an operating system stored in the memory 224 or within an auxiliary memory within the CPU 220. The functions performed by CPU 220 are controlled by one or more control programs or applications stored in memory 224. Operating system and applications are comprised of instructions which, when read and executed by the CPU 220, cause the receiver 204 to perform the functions and steps necessary to implement and/or use the present invention, typically, by accessing and manipulating data stored in the memory 224. Instructions implementing such applications are tangibly embodied in a computer-readable medium, such as the memory 224 or the access card 212. The CPU 220 may also communicate with other devices through interface 228 or the receiver dish 108 to accept commands or instructions to be stored in the memory 224, thereby making a computer program product or article of manufacture according to the invention. As such, the terms “article of manufacture,” “program storage device” and “computer program product” as used herein are intended to encompass any application accessible by the CPU 220 from any computer readable device or media.

Memory 224 and access card 212 store a variety of parameters for receiver 204, such as a list of channels receiver 204 is authorized to process and generate displays for; the zip code and area code for the area in which receiver 204 is used; the model name or number of receiver 204; a serial number of receiver 204; a serial number of access card 212; the name, address and phone number of the owner of receiver 204; and the name of the manufacturer of receiver 204.

Access card 212 is removable from receiver 204 (as shown in FIG. 2). When inserted into receiver 204, access card 212 is coupled to access card interface 232, which communicates via interface 228 to a customer service center (not pictured). Access card 212 receives access authorization information from the customer service center based on a user's particular account information. In addition, access card 212 and the customer service center communicate regarding billing and ordering of services.

Clock 222 provides the current local time to CPU 220. Interface 228 is preferably coupled to a telephone jack 234 at the site of IRD 112. Interface 228 allows receiver 204 to communicate with transmission station 102 as shown in FIG. 1 via telephone jack 234. Interface 228 may also be used to transfer data to and from a network, such as the Internet.

The signals sent from receiver dish 108 to tuner 214 are a plurality of modulated Radio Frequency (RF) signals. The desired RF signal is then downconverted to baseband by the tuner 214, which also generates in-phase and quadrature-phase (I and Q) signals. These two signals are then passed to the demodulator/FEC Application Specific Integrated Circuit (ASIC) 216. The demodulator 216 ASIC then demodulates the I and Q signals, and the FEC decoder correctly identifies each transmitted symbol. The received symbols for Quaternary Phase Shift Keying (QPSK) or 8PSK signals carry two or three data bits, respectively. The corrected symbols are translated into data bits, which in turn are assembled in to payload data bytes, and ultimately into data packets. The data packets may carry 130 data bytes or 188 bytes (187 data bytes and 1 sync byte). These data packets are then further divided into audio and video portions for display on monitor 114.

In addition to the digital satellite signals received by receiver dish 200, other sources of television content are also preferably used. For example, alternate content source 202 provides additional television content to monitor 114. Alternate content source 202 is coupled to tuner 214. Alternate content source 202 can be an antenna for receiving off the air signals National Television Standards Committee (NTSC) signals, a cable for receiving American Television Standards Committee (ATSC) signals, or other content source. Although only one alternate content source 202 is shown, multiple sources can be used.

Initially, as data enters receiver 204, CPU 220 looks for initialization data which is referred to commonly in the industry as a boot object. A boot object identifies the SCIDs where all other program guide objects can be found. Boot objects are always transmitted with the same SCID, so CPU 220 knows that it must look for packets marked with that SCID. The information from the boot object is used by CPU 220 to identify packets of program guide data and route them to memory 224.

Remote control 210 typically emits Infrared (IR) signals 236 that are received by infrared receiver 230 in receiver 204. Other types of data entry devices may alternatively be used, by way of example and not limitation, such as an ultra-high frequency (UHF) remote control, a keypad on receiver 204, a remote keyboard and a remote mouse. When a user requests the display of a program guide by pressing the “guide” button on remote control 210, a guide request signal is received by IR receiver 230 and transmitted to logic circuit 226. Logic circuit 226 informs CPU 220 of the guide request. In response to the guide request, CPU 220 causes memory 224 to transfer a program guide digital image to D/A converter 218. D/A converter 218 converts the program guide digital image into a standard analog television signal, which is then transmitted to monitor 114. Monitor 114 then displays the TV video and audio signals. Monitor 114 may alternatively be a digital television, in which case no digital to analog conversion in receiver 204 is necessary.

Users interact with the electronic program guide using remote control 210. Examples of user interactions include selecting a particular channel or requesting additional guide information. When a user selects a channel using remote control 210, IR receiver 230 relays the user's selection to logic circuit 226, which then passes the selection on to memory 224 where it is accessed by CPU 220. CPU 220 performs an MPEG2 decoding step on received audio, video, and other packets from FEC decoder 216 and outputs the audio and video signals for the selected channel to D/A converter 218. D/A converter 218 converts the digital signals to analog signals, and outputs the analog signals to monitor 114.

As the number of satellites 106 increases, the number of programming choices increases. With the proliferation of recording devices 208 as an integrated part of IRD 112, many users record programs for viewing at a later time. Recording devices 208, and PVR/IRD 112 technology in general, now allow users to view programs at a faster or slower rate than originally recorded. For example, certain scenes can be played at slow motion to review a specific part of a video program, or scenes can be played at a faster rate to compress the time required to watch a specific program. Such changes in playback speeds are desired by viewers for these and other reasons.

However, when a video portion of a recorded program is played at a non-original speed, the audio portion is also played at a non-original speed. Such playback techniques result in a different pitch of the audio portion, based on the playback speed of the video. For example, if a program is played back at a higher than original speed, the audio portion typically sounds higher in pitch than normal as well as faster than normal audio speed, making the audio track difficult to understand. Similarly, by slowing down the video, words and sounds are elongated and are played back at a lower than original pitch, also making the audio portion of a given program difficult to understand for viewers.

It can be seen, then, that there is a need in the art for a system that can correct audio pitch for video programming that is replayed at a non-original speed.

### SUMMARY OF THE INVENTION

To minimize the limitations in the prior art, and to minimize other limitations that will become apparent upon reading and understanding the present specification, the present invention discloses a system for providing substantially correct pitch audio associated with video played back at a rate other than originally recorded. A system in accordance with the present invention comprises a record/playback device, wherein the record/playback device records audio programming and associated video programming at a normal speed and plays back the recorded audio programming and associated video programming at a range of speeds, a computer, coupled to the record/playback device, for determining the playback speed of the record/playback device, and an audio controller, coupled to the computer, for amending the audio programming to match a playback speed of the associated video programming while substantially maintaining the pitch of the audio programming.

Such a system optionally includes the record/playback device being a Digital Video Recorder (DVR), the audio programming and associated video programming being provided by a direct broadcast satellite (DBS) system, the record/playback device further comprising an Integrated Receiver/Decoder (IRD), the IRD and DVR beinge characterized prior to delivery to a customer, the IRD and DVR being programmed to deliver the amended audio programming within a range of playback speeds, and when the requested playback speed is outside the range, the amended audio programming is muted.

Such a system can also optionally include the IRD using Time Scale Modification (TSM) to amend the audio programming, the TSM using a Synchronized Overlap and Add (SOLA) algorithm, the user overriding the amendment of the audio programming, and the amendment of the audio programming being user selectable.

An alternate system for playing back recorded satellite signals, wherein a video portion of the recorded satellite signal is played back at a rate other than originally recorded while an audio portion of the recorded satellite signal substantially retains an original pitch, comprises a receiver, coupled to an antenna, for receiving the satellite signals, a decoder, coupled to the receiver, for decoding the satellite signals, a record/playback device, wherein the record/playback device records the decoded satellite signals as audio programming and associated video programming, the record/playback device recording the audio programming and associated video programming at a normal speed, a computer, coupled to the record/playback device, for determining the playback speed of the record/playback device, and an audio controller, coupled to the computer, for amending the audio programming to match a playback speed of the associated video programming while substantially maintaining the pitch of the audio programming.

Such a system optionally includes the record/playback device being a Digital Video Recorder (DVR), the audio programming and associated video programming being provided by a direct broadcast satellite (DBS) system, the IRD and DVR being characterized prior to delivery to a customer, the IRD and DVR being programmed to deliver the amended audio programming within a range of playback speeds, and when the requested playback speed is outside the range, the amended audio programming is muted.

Such an alternate system can also optionally include the computer using Time Scale Modification (TSM) to amend the audio programming. the TSM using a Synchronized Overlap and Add (SOLA) algorithm, a user overriding the amendment of the audio programming, and the amendment of the audio programming being user selectable.

Other features and advantages are inherent in the system and method claimed and disclosed or will become apparent to those skilled in the art from the following detailed description and its accompanying drawings.

### BRIEF DESCRIPTION OF THE DRAWINGS

Referring now to the drawings in which like reference numbers represent corresponding parts throughout:

FIG. 1 illustrates a typical satellite television installation of the related art;

FIG. 2 is a block diagram of a typical IRD, which receives and decodes audio, video and data signals;

FIG. 3 illustrates a block diagram of the present invention; and

FIGS. 4A-4D illustrates the Synchronized Overlap and Add (SOLA) method which can be used in conjunction with the present invention.

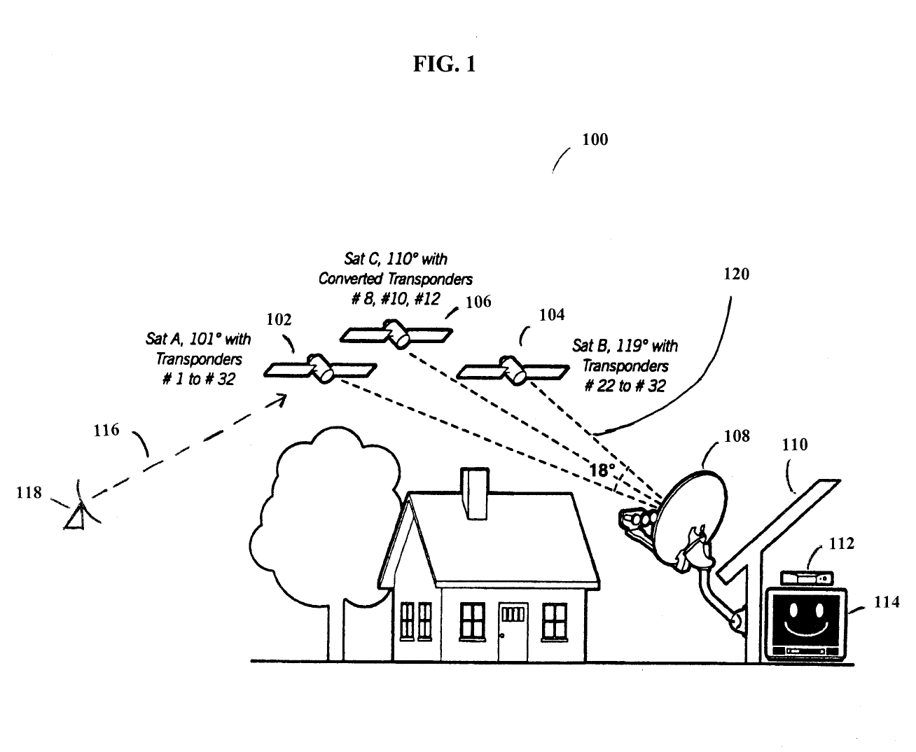

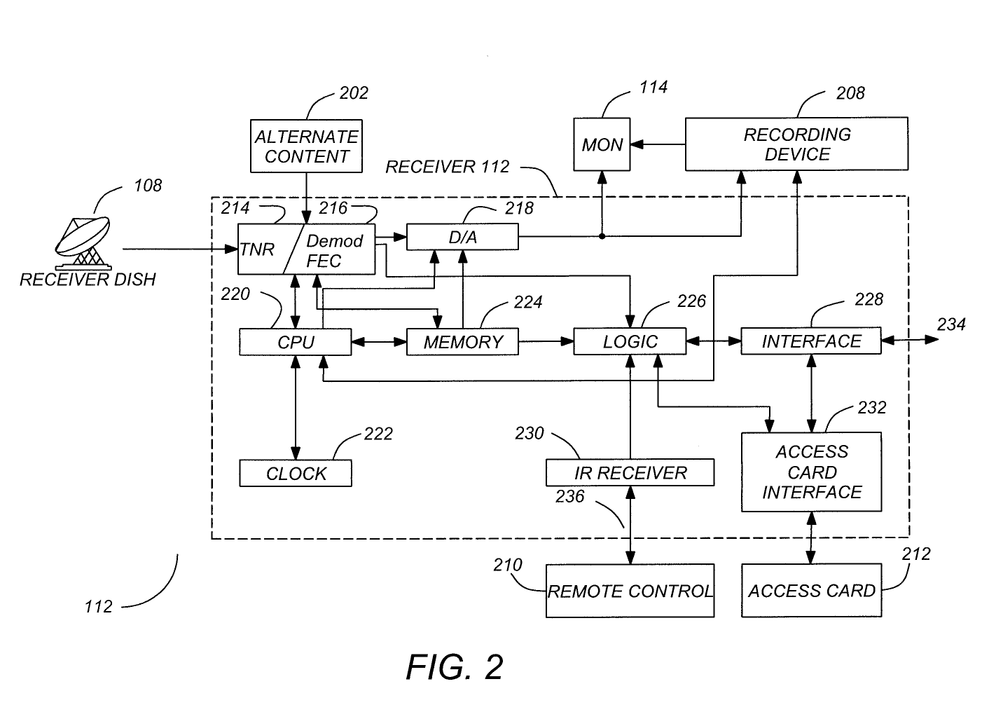

### DETAILED DESCRIPTION OF PREFERRED EMBODIMENTS

In the following description, reference is made to the accompanying drawings which form a part hereof, and which show, by way of illustration, several embodiments of the present invention. It is understood that other embodiments may be utilized and structural changes may be made without departing from the scope of the present invention.

### Overview

Audio recordings, of musical instruments, voice, and other aural intonations, have several components. Music is typically described by notes, tempo, and timbre, where the notes are the physical frequency of vibration of an instrument, the tempo is how fast the notes are being played, and the timbre is the quality of the overtones, etc. that accompany a specific note. So, for example, a flute can play an “A” at 442 Hz at a rate of 108 notes per second, and a silver flute will have a different timbre than a gold flute even at the note and frequency listed. The present invention does not disturb the 442 Hz tone (the “pitch” of the note itself), nor does the present invention attempt to affect the timbre; the present invention merely speeds up the succession of notes to a faster rate (the “tempo of the music”), e.g., 120 notes per second. Similar concepts apply to voice and other audio components.

The present invention covers the application of audio delivery in connection with trick play playback, either slow or fast forward speeds. If the CPU can keep up playback of a synthesized compressed or expanded audio signal, then the audio will be presented during the trick mode speeds. For example, the CPU can do the work up front prior to playback to create the synthesized signal, or a separate CPU can do such computation and synthesis. If the compressed or expanded audio signal cannot be computationally maintained, then the audio will mute and the trick mode speed will not have accompanying audio.

Present DVR 112 devices can record television and time shift it to be viewed at a later time. Some DVR 112 devices allow fast forward, rewind, and slow-motion controls of one or more speeds, and others allow skip ahead increments in thirty second or sixty second jumps.

Such special playback modes are called “trick play” modes, where the DVR 112 plays the recorded material in a special manner. For example, when a DVR 112 records a program, it records it at the rate the program would normally be played. If the DVR 112 then plays the program at a rate other than a normal playback rate, such a playback of the program is done using “trick play” modes of the DVR 112. These modes include rates as fast as 1.2 times the normal playback rate, and as slow as 0.8 times the normal playback rate.

Further, trick play modes can include “skip” modes, where the DVR 112 skips over a segment of recorded information. So, for example, a viewer can press a button on the remote control and pass over information based on a specific command sent to the DVR 112. Such a skip command may skip thirty seconds of information from the point where the button was pressed, sixty seconds of information, or, if desired, can skip information based on the type of information. Such “type-based” skips can be used to skip specific types of frames, such as I-frames (anchor frames), P-frames, and B-frames. A DVR 112 can search for a specific I-frame and skip to that I-frame, skipping over other I-frames, P-frames, and B-frames in the process. However, when the DVR 112 plays the material at a faster than normal rate, not only is the video information presented at a faster tempo, the audio information is presented at the same tempo without corresponding pitch correction.

The present invention permits the DVR to offer audio over slower speeds or faster speeds than originally recorded without a pitch change or degrading the sound quality. Faster viewing speeds, i.e., at a speed faster than originally recorded, or faster than a normal playback speed for a given video program, allow a customer to decrease their viewing time while still enjoying the recorded program. For example, viewing a program at 20% faster speed allows customers to view a sixty-minute program in forty-eight minutes.

With the present invention, viewers can hear audio without pitch distortion or audio degradation while viewing a program in slow motion or fast forward speeds on a DVR 112 device. The viewer can hurry up a program's action, e.g., changing the playback speed from 1× to 1.2×, or some other fraction, and watch the remainder in a shorter time, with the audio pitch automatically adjusted to the selected playback speed and presented with normal pitch. As such, the present invention provides audio pitch correction based on the increased or decreased play rate, and by correcting the audio pitch by the same rate adjustment. Audio compression techniques allow for faster audio playback without a change in pitch.

### Block Diagram

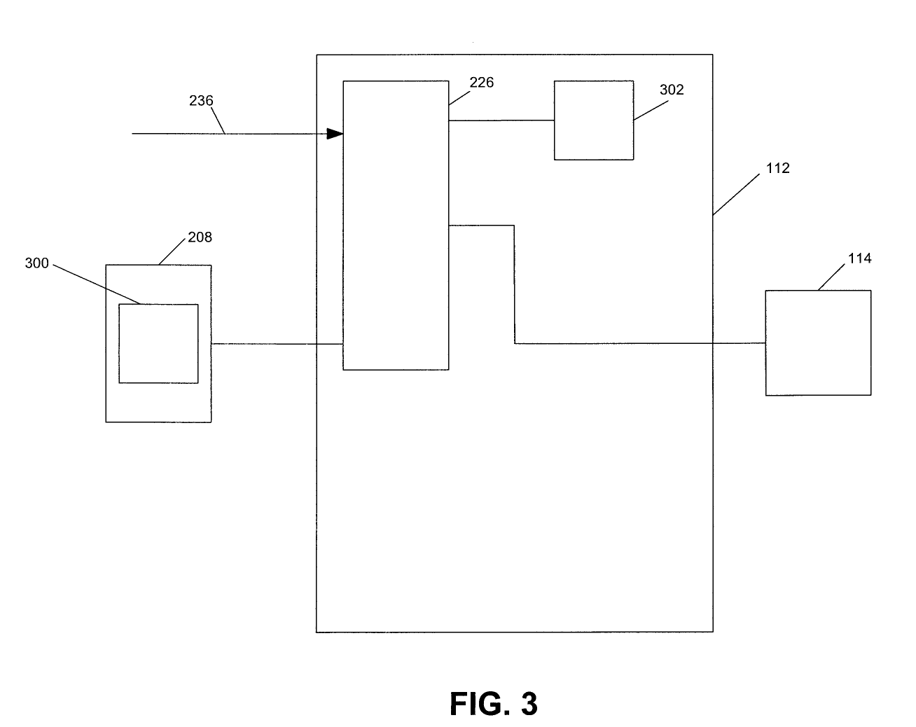

FIG. 3 illustrates a block diagram of an embodiment of the present invention.

FIG. 3 illustrates an IRD 112, receiving a command 236 from a remote control or front panel button, to play a recorded program 300 that is stored on recording device 208 at a speed faster or slower than “normal” speed. When logic 226 receives command 236, the playback speed that is desired by the viewer, e.g., 1.2 times faster than normal, 0.8 times normal speed, etc., is part of command 236. Such a speed increase or reduction is passed onto audio controller 302, which uses this increase or decrease factor to determine how best to increase or decrease the audio portion of the recording stored on recording device 208.

For example, if the differential between the requested playback speed and the normal playback speed for recording 300 is small, audio controller 302 may not need to perform any modifications to the audio portion of the recording 300. However, once the differential between the requested playback speed and the normal playback speed surpasses a certain threshold, the audio controller 302 begins applying a Time Scale Modification (TSM), which, in essence, removes the “spaces” between words while maintaining the pitch of the audio portion of recording 300.

TSM includes both compression (e.g., speeding up) and expansion (e.g., slowing down) of the audio portion of recording 300. TSM prioritizes the preservation of the pitch of the audio portion of recording 300 while changing the tempo of the audio portion of the recording 300. However, other techniques may be used that sacrifice pitch at speeds where pitch cannot be preserved, or combines both pitch modification and tempo modification, to allow the audio portion of recording 300 to be presented on monitor 114 during playback of recording 300 that is at a non-original speed.

Of course, logic 226, perhaps in conjunction with audio controller 302, may determine that the audio portion of recording 300 cannot be corrected enough for a given playback speed. For example, if a viewer requests a playback speed that is twenty times slower than normal, the logic 226 and/or audio controller 302 may determine that the audio portion of recording 300 would be so slurred that the audio portion of recording 300 would be unintelligible to the viewer. For such conditions, logic 226 can optionally mute the audio portion of recording 300, unless the viewer wishes to override such muting of the audio portion.

### Synchronized Overlap and Add

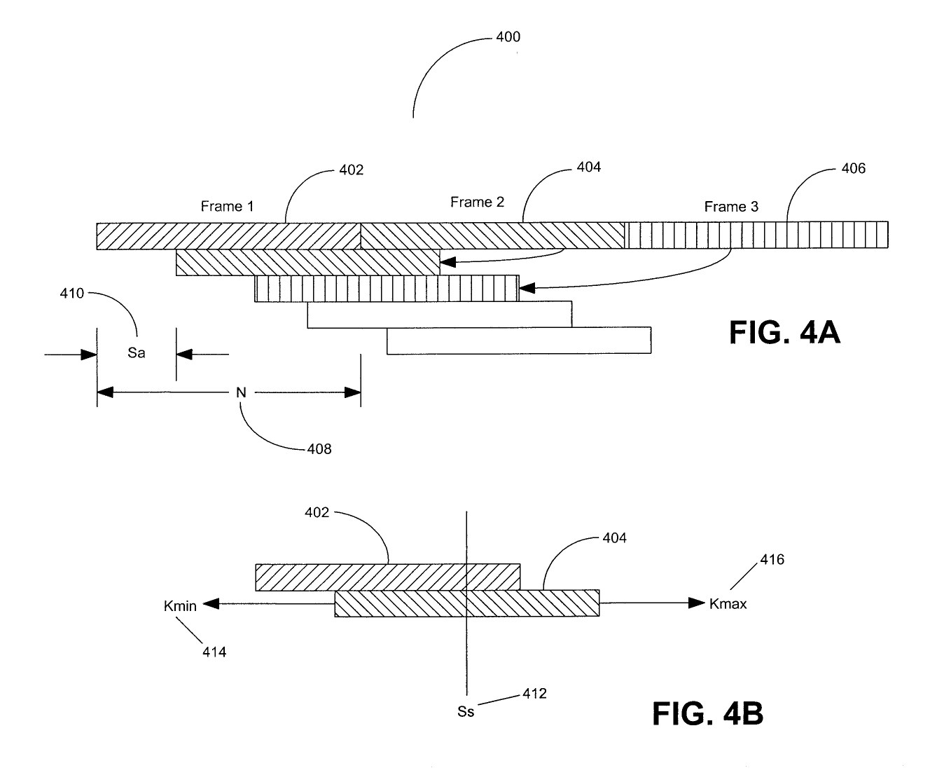

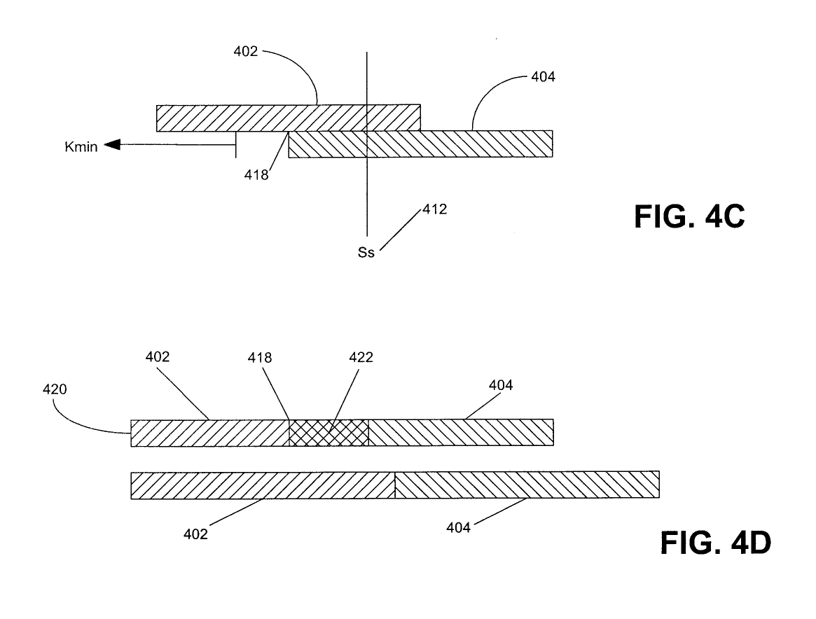

FIGS. 4A-4D illustrates the Synchronized Overlap and Add (SOLA) method which can be used in conjunction with the present invention.

FIG. 4A illustrates audio portion 400, which comprises frames 402, 404, and 406. There can be additional frames 402-406 in audio portion 400 without departing from the scope of the present invention. Each frame 402-406 is of length N 408 bits, such that frames 402-406 can be compressed or expanded to any length of N bits desired. The example here is shown for compression of the frames 402-406 into a time period shorter than that of frames 402-406 played sequentially. If frames 402-406 were to be played sequentially, such a playback would be a “normal” or “original” speed playback, and no TSM would be required to preserve the pitch of audio portion 400.

Frame 404 is placed in an overlapping position with frame 402, such that the beginning of frame 404 is a distance Sa from the beginning of frame 402. Similarly, frame 406 is placed placed in an overlapping position with frame 404, such that the beginning of frame 406 is a distance Sa 410 from the beginning of frame 404.

FIG. 4B illustrates that frame 404 is moved or otherwise shifted with respect to frame 402, beginning at point Ss 412 and in both directions. Frame 404 is moved towards the beginning of frame 402 up to an amount of Kmin 414, and frame 404 can also be moved towards the end of frame 402 up to an amount of Kmax 416. It should be noted that Kmin 414 cannot be before the beginning of frame 402, and Kmax 416 cannot be after the end of frame 402 for compression of signal 400.

FIG. 4C illustrates point 418 where the cross-correlation between frame 402 and frame 404 is maximized. By maximizing the cross correlation between frames 402 and 404, the “spaces” between sounds on the audio portion 400 are eliminated. The initial, or final positions or determinations of Kmin 414, Kmax 416, and Ss 412, can be determined by the cross correlation function as well as the requested playback speed from signal 236.

FIG. 4D illustrates synthesized signal 420, comprised of frames 402 and 404 added together. Initially, frame 402 is added directly to synthesized signal 420, and frame 404 is added to signal 420 after point 418 is determined, so that audio controller 302 knows where in signal 420 to add frame 404. After the frames 402 and 404 are added together in such a manner as shown in FIGS. 4A-4D, frame 406, and any successive frames, are added to signal 420. Shown for comparison in terms of compression of audio signal 400 are frames 402 and 404 in sequential order, and a shortening of time 422 is indicated.

As such, the signal is processed as follows:

$${R}^{′} [ k ] = \frac{{\sum }_{i = 0}^{{L}_{k} - 1} y [ {mS}_{s} + k + i ] \cdot x [ {mS}_{a} + i ]}{{[ {\sum }_{i = 0}^{{L}_{k} - 1} {y}^{2} [ {mS}_{s} + k + i ] \cdot {\sum }_{i = 0}^{{L}_{k} - 1} {x}^{2} [ {mS}_{a} + i ] ]}^{1 / 2}}$$

Where Sa and Ss are the analysis and synthesis frame periods, respectively, related by Ss=αSa, α being the time scaling factor.

For any m>0, the (m+1)th frame which starts at mSa is shifted along the synthesized signal 400 y(n) around the target location mSs within the range of (kmin, kmax) to find a location which maximizes the cross-correlation function, R′(k), defined above, where Lk is the length of the overlapping region between the shifted analysis frame and synthesized signal. With the optimal location found, the overlapping region is cross-faded and the rest of the analysis frame, if any is directly copied to the synthesized signal. Usually kmin 414 and kmax 416 are set to be −N/2 and N/2 respectively. The Lk can take on any integer between 0 and N and its value depends on the lag and the time-varying length of the synthesized signal.

### Other Aspects of the Invention

In another aspect of the invention, the DVR 112 can be pre-tested and calibrated during development to ascertain its computational ability, and is codified so that, at certain predefined speeds, the audio portion 400 will be TSM corrected, and at greater speeds than can be computationally maintained, the audio portion 400 will be muted during trick play.

Yet in another aspect, the audio portion 400 is still presented during trick mode without pitch correction, either because the results are found to be acceptable, or because the pitch change is desirable. It is desirable to have certain speeds, such as fast forward at 1.2× rate or slower, have accompanying audio presented at the higher tempo and higher pitch while performing no TSM correction, because the higher pitch is barely discernable or enjoyable.

Further, it is desirable to allow for the option of turning pitch correction on and off. So, for example, a DVR 112 device might employ no TSM correction at speeds of 1 to 1.2×, employ TSM correction at speeds from 1.2-4×, and because computational speed limitations prevent the TSM algorithm from being applied above 4×, mute the audio at speeds above 4×. Further, the viewer can enable/disable TSM correction per the viewer's desires.

Further, a viewer may wish to employ audio pitch changes as an entertainment or enhancement application, and adjust the broadcast audio with various audio effects, such as simulated concert hall acoustics, echo, chromatic pitch change, and key changes to music. Such viewer-determined pitch corrections or TSM applications are possible with the present invention.

### CONCLUSION

In summary, the present invention discloses a system for providing substantially correct pitch audio associated with video played back at a rate other than originally recorded. A system in accordance with the present invention comprises a record/playback device, wherein the record/playback device records audio programming and associated video programming at a normal speed and plays back the recorded audio programming and associated video programming at a range of speeds, a computer, coupled to the record/playback device, for determining the playback speed of the record/playback device, and an audio controller, coupled to the computer, for amending the audio programming to match a playback speed of the associated video programming while substantially maintaining the pitch of the audio programming.

Such a system optionally includes the record/playback device being a Digital Video Recorder (DVR), the audio programming and associated video programming being provided by a direct broadcast satellite (DBS) system, the record/playback device further comprising an Integrated Receiver/Decoder (IRD), the IRD and DVR beinge characterized prior to delivery to a customer, the IRD and DVR being programmed to deliver the amended audio programming within a range of playback speeds, and when the requested playback speed is outside the range, the amended audio programming is muted.

Such a system can also optionally include the IRD using Time Scale Modification (TSM) to amend the audio programming, the TSM using a Synchronized Overlap and Add (SOLA) algorithm, the user overriding the amendment of the audio programming, and the amendment of the audio programming being user selectable.

An alternate system for playing back recorded satellite signals, wherein a video portion of the recorded satellite signal is played back at a rate other than originally recorded while an audio portion of the recorded satellite signal substantially retains an original pitch, comprises a receiver, coupled to an antenna, for receiving the satellite signals, a decoder, coupled to the receiver, for decoding the satellite signals, a record/playback device, wherein the record/playback device records the decoded satellite signals as audio programming and associated video programming, the record/playback device recording the audio programming and associated video programming at a normal speed, a computer, coupled to the record/playback device, for determining the playback speed of the record/playback device, and an audio controller, coupled to the computer, for amending the audio programming to match a playback speed of the associated video programming while substantially maintaining the pitch of the audio programming.

Such a system optionally includes the record/playback device being a Digital Video Recorder (DVR), the audio programming and associated video programming being provided by a direct broadcast satellite (DBS) system, the IRD and DVR being characterized prior to delivery to a customer, the IRD and DVR being programmed to deliver the amended audio programming within a range of playback speeds, and when the requested playback speed is outside the range, the amended audio programming is muted.

Such an alternate system can also optionally include the computer using Time Scale Modification (TSM) to amend the audio programming. the TSM using a Synchronized Overlap and Add (SOLA) algorithm, a user overriding the amendment of the audio programming, and the amendment of the audio programming being user selectable.

Further, such systems in accordance with the present invention can be implemented in cable or terrestrial broadcast television systems, and other audio/video delivery systems, without departing from the scope of the present invention.

It is intended that the scope of the invention be limited not by this detailed description, but rather by the claims appended hereto and the equivalents thereof. The above specification, examples and data provide a complete description of the manufacture and use of the composition of the invention. Since many embodiments of the invention can be made without departing from the spirit and scope of the invention, the invention resides in the claims hereinafter appended and the equivalents thereof.

What is claimed is:

1. A system for providing substantially correct pitch audio associated with video played back at a rate other than originally recorded, comprising:
a record/playback device, wherein the record/playback device records audio programming and associated video programming at a normal speed and plays back the recorded audio programming and associated video programming at a range of speeds;
a computer, coupled to the record/playback device, for determining the playback speed of the record/playback device; and
an audio controller, coupled to the computer, for amending the audio programming to match a playback speed of the associated video programming while substantially maintaining the pitch of the audio programming.

2. The system of claim 1, wherein the record/playback device is a Digital Video Recorder (DVR).

3. The system of claim 2, wherein the audio programming and associated video programming is provided by a direct broadcast satellite (DBS) system.

4. The system of claim 3, wherein the record/playback device further comprises an Integrated Receiver/Decoder (IRD).

5. The system of claim 4, wherein the IRD and DVR are characterized prior to delivery to a customer.

6. The system of claim 5, wherein the IRD and DVR are programmed to deliver the amended audio programming within a range of playback speeds.

7. The system of claim 6, wherein when the requested playback speed is outside the range, the amended audio programming is muted.

8. The system of claim 4, wherein the IRD uses Time Scale Modification (TSM) to amend the audio programming.

9. The system of claim 8, wherein the TSM uses a Synchronized Overlap and Add (SOLA) algorithm.

10. The system of claim 4, wherein a user can override the amendment of the audio programming.

11. The system of claim 1, wherein the amendment of the audio programming is user selectable.

12. A system for playing back recorded satellite signals, wherein a video portion of the recorded satellite signal is played back at a rate other than originally recorded while an audio portion of the recorded satellite signal substantially retains an original pitch, comprising:
a receiver, coupled to an antenna, for receiving the satellite signals;
a decoder, coupled to the receiver, for decoding the satellite signals;
a record/playback device, wherein the record/playback device records the decoded satellite signals as audio programming and associated video programming, the record/playback device recording the audio programming and associated video programming at a normal speed;
a computer, coupled to the record/playback device, for determining the playback speed of the record/playback device; and
an audio controller, coupled to the computer, for amending the audio programming to match a playback speed of the associated video programming while substantially maintaining the pitch of the audio programming.

13. The system of claim 12, wherein the record/playback device is a Digital Video Recorder (DVR).

14. The system of claim 13, wherein the audio programming and associated video programming is provided by a direct broadcast satellite (DBS) system.

15. The system of claim 14, wherein the IRD and DVR are characterized prior to delivery to a customer.

16. The system of claim 15, wherein the IRD and DVR are programmed to deliver the amended audio programming within a range of playback speeds.

17. The system of claim 16, wherein when the requested playback speed is outside the range, the amended audio programming is muted.

18. The system of claim 12, wherein the computer uses Time Scale Modification (TSM) to amend the audio programming.

19. The system of claim 18, wherein the TSM uses a Synchronized Overlap and Add (SOLA) algorithm.

20. The system of claim 12, wherein a user can override the amendment of the audio programming.
